(19) United States
(12) Patent Application Publication
(10) Pub. No.: US 2016/0214037 A1
(43) Pub. Date: Jul. 28, 2016

(54) INORGANIC PARTICLE POLYMER HYBRIDS AND USES THEREOF

(71) Applicant: Alberta Innovates - Technology Futures, Edmonton (CA)

(72) Inventors: Haihong LI, Edmonton (CA); Zhiang (Joe) ZHOU, Edmonton (CA); Ross CHOW, Edmonton (CA); Xinghua MO, Edmonton (CA); Harold Bernard KRENKEL, Sherwood Park (CA)

(21) Appl. No.: 15/091,815

(22) Filed: Apr. 6, 2016

Related U.S. Application Data
(63) Continuation-in-part of application No. 14/663,344, filed on Mar. 19, 2015.
(60) Provisional application No. 61/968,201, filed on Mar. 20, 2014.

(51) Int. Cl. B01D 21/01

(52) U.S. Cl. CPC B01D 21/01

(57) ABSTRACT

Described herein is combination of flocculants for flocculating fines solids in a suspension thereof. The combination includes: (a) an anionic polymer flocculant, and (b) a charged particle-polymer hybrid flocculant that includes charged core particles having an average size between about 150 nm and about 800 nm and each having a polymer polymerized thereon. The anionic polymer flocculant is to be added before, or at substantially the same time as, the charged particle-polymer hybrid flocculant.

### CROSS REFERENCE TO RELATED APPLICATIONS

This application is a continuation-in-part of U.S. patent application Ser. No. 14/663,344 filed Mar. 19, 2015, which claims the benefit of priority of U.S. Provisional Patent Application No. 61/968,201 filed Mar. 20, 2014, which is hereby incorporated by reference.

### FIELD

The present disclosure relates generally to combinations of anionic polymers and inorganic particle polymer hybrids that are used together as flocculants.

### BACKGROUND

Flocculation is a process where microscopic substances that are suspended in a liquid carrier aggregate to form larger-sized clusters, also known as flocs or flakes, and come out of suspension. Flocculation may be accelerated by the addition of a flocculating agent to the suspension, where the flocculating agent interacts with the microscopic substances to aid in the aggregation and formation of the flocs that come out of suspension.

Flocculation may be used in a variety of industries, such as: mining; mineral processing; coal mining; water treatment; pulp and paper processing, for example de-inking; wastewater treatment; soil cleaning; oil and gas industry, for example: waste oil recovery, or treatment of tailings or wastewater; or in any industry that uses solid-water separation.

Polyacrylamide (PAM) polymers have been used as flocculating agents. PAM-based flocculants that are commonly used in commercial processes often have shortcomings, for example:
linear PAM, which has a high molecular mass, may be broken down into smaller, shorter molecules of polymer under mechanical mixing and turbulent flow conditions, thereby reducing its efficiency;
ionic PAM chains become stretched by incorporation of charged anionic or cationic monomer sites that repel each other along the length of the polymer (while the charged sites on the PAM chains may increase the effectiveness of aggregation with the dispersed substances, they also limit how closely the aggregated particles may be drawn together, thereby resulting in loose, fragile, floccules that retain undesirable amounts of water); and
PAM-based flocculants may operate within a relatively narrow concentration range, outside of which the flocculating performance decreases (over-dosing may result in curling of PAM molecules and reduced effectiveness, or may result in dispersion of the suspended solid particles).

Hybrid particle combinations of charged cores and PAM have been made (see: Yang, W.; Qian, J.; Shen, Z. A novel flocculant of Al(OH)₃-polyacrylamide ionic hybrid. J. Colloid Interface Sci. 2004, 273, 400-405.; Wang, M., Qian, J., Zheng, B. and Yang, W. Preparation, characteristics, and flocculation behavior of modified palygorskite-polyacrylamide ionic hybrids. J. Appl. Polym. Sci. 2006, 101, 1494-1500.; and Qiao Feng et al., Synthesis of Macroporous Polyacrylamide and Poly (N-isopropylacrylamide) Monoliths via Frontal Polymerization and Investigation of Pore Structure Variation of Monoliths. Chinese J. Polym. Sci. 2009, 27, 747) and used as flocculants. These particles include: palygorskite-PAM particles, aluminum hydroxide-PAM particles; and N-isopropyl acrylamide-PAM particles.

Hybrid particle combinations of Fe(OH)₃ cores and PAM, as well as Al(OH)₃ cores and PAM, are disclosed in WO2012021987 (PCT Application No: CA2011/050338). The disclosed particles are formed by the synthesis of “sub-micron cores” of metal-hydroxide and subsequent polymerization of the sub-micron cores with acrylamide monomer. The sub-micron particles disclosed in WO2012021987 were made following a procedure disclosed in Yang et al. 2004. Yang states that the procedure produces a charged particle-polymer hybrid (CPPH) flocculant that includes a charged core and a polymerized surface polymer sized between 78 nm and 150 nm. The charged particle-polymer hybrid of WO2012021987 was found to have a charged core and a polymerized surface polymer size similar to Yang's but was determined to have a modified intrinsic viscosity of 766 mL/g.

It is, therefore, desirable to provide a charged particle polymer hybrid flocculant having improved flocculating properties, such as the ability to flocculate at elevate levels of solids or particles in fine size, or the ability to form flocs with high yield stress.

### SUMMARY

The authors of the present disclosure have found that flocculation using the charged particle-polymer hybrid flocculants described herein is improved when an anionic polymer flocculant is added to the suspension.

In a first aspect, the present disclosure provides a combination of flocculants, where the combination comprises (a) an anionic polymer flocculant, and (b) a charged particle-polymer hybrid flocculant that includes charged core particles having an average size between about 150 nm and about 800 nm and each having a polymer polymerized thereon, where the anionic polymer flocculant is to be added before, or at substantially the same time as, the charged particle-polymer hybrid flocculant.

In some examples, using the combination of flocculants reduces the total flocculant dosage compared to the flocculant dosage when only one of the flocculants in the combination is used. In some examples, the combination of flocculants increases the settling rate of a suspension compared to the settling rate of the suspension when only one of the flocculants in the combination is used.

The anionic polymer flocculants may be a polyacrylamide (PAM)-based polymer, preferably with a high molecular weight (such as a molecular weight above about 1×10⁶ Daltons). The anionic polymer flocculant may be branched or linear, with branched polymers being preferred. The most preferred anionic polymer is the anionic, branched PAM-based polymer SNF3338™, sold by SNF Canada (Trois-Rivieres, Quebec, Canada), which is an polyacrylamide-sodium polyacrylate co-polymer having about 25% to about 30% charge density.

Preferably, the charged core particles have an average size between about 340 nm and about 750 nm, and more preferably the charged core particles have an average size between about 500 nm and about 750 nm.

The charged core particle may include Al(OH)₃ or Fe(OH)₃. The polymer polymerized on the charged core particles may be a polyacrylamide.

In another aspect, there is provided a method of forming a charged particle-polymer hybrid flocculant. The method includes forming charged core particles having an average size between about 150 nm and about 800 nm; and polymerizing a monomer on the charged core particles.

Forming charged core particles may include reacting ammonium carbonate with a metal chloride, and may preferably include selecting a ratio between the ammonium carbonate to the metal chloride to control the size of the metal hydroxide particles. Preferably, the charged core particles have an average size between about 340 nm and about 750 nm, and more preferably the charged core particles have an average size between about 500 nm and about 750 nm.

Without wishing to be bound by theory, the authors of the present disclosure believe that the flocculating efficacy is a function of the size of the flocculant particles relative to the size of the solids being removed from suspension. It is believed that using flocculant particles that are too small for a given size of solid results in reduced efficacy because the contact frequency between the flocculant particles and the solids being removed from suspension is reduced as the size of the flocculant particles is decreased, while using flocculant particles that are too large for a given size of solids results in reduced efficacy because the specific total solid/liquid surface area and the number of the flocculant particles available for capturing the solids to be flocculated per unit weight of solids is reduced. It is believed that the contact frequency is decreased when reducing the size of flocculant particles because there is increased thermal motion of the flocculant particles as the size of the flocculant particles is reduced. It is also believed that an increase in thermal motion of flocculant particles increases the likelihood that captured solids will detach from the flocculant particles.

The authors of the present disclosure have identified flocculant particles that are particularly effective for flocculating oil sands mature fine tailings (MFT), which is also referred to as fluid fine tailings (FFT), which predominantly have clay particles with diameters smaller than 10 microns (10,000 nm), with the finest size fraction having diameters from about 50 to about 500 nm. Flocculant particles according to the present disclosure that are particularly effective for flocculating oil sands mature fine tailings have an average size between about 340 nm and about 750 nm.

Matured fine tailings, or fluid fine tailings in oil sands extraction may have up to about 35 wt. % solids after being consolidation for a period of time, for example a number of years. Greater than 97% of all the solids in MFT are smaller than 44 μm, and most samples of fine solids have an average size (d50) of less than 0.2 μm. Without wishing to be bound by theory, the authors of the present disclosure believe that, at least for some concentrations of oil sands mature fine tailings, the flocculating efficacy is more a function of the size of the flocculant particles for a given percent solids, and less a function of the concentration (ppm) of flocculant particles used. It is believed that both smaller flocculant particles according to the present disclosure, for example around 340 nm, and larger flocculant particles according to the present disclosure, for example between about 500 nm and about 750 nm, are effective at flocculating oil sands mature fine tailings or fluid fine tailings with lower percent solids, for example 5% solids, but that oil sands mature fine tailings or fluid fine tailings with higher percent solids, for example 10% solids, require larger flocculant particles according to the present disclosure, for example between about 500 nm and about 750 nm.

Yield stress of a floc is a factor in the floc strength. Yield stress is a reflection of how easily the flocs are broken into smaller particles. Smaller particles are less desirable than larger particles since the smaller particles are more difficult to remove and more readily foul separating equipment, such as filtration membranes. In selecting a flocculant to use, it is desirable to select a flocculant that generates a floc with a higher yield stress. Flocculants according to the present disclosure, having an average size of about 340 nm to about 750 nm generate flocs with yield stresses above about 500 Pa, such as between about 500 Pa and about 600 Pa. Flocs from oil sands mature tailings with yield strengths above about 500 Pa may resist breakdown by hydrodynamic forces during a solid-liquid separation process, such as filtration, thereby facilitating transport and further processing of the flocculated tailings.

Other aspects and features of the present disclosure will become apparent to those ordinarily skilled in the art upon review of the following description of specific examples in conjunction with the accompanying figures.

### BRIEF DESCRIPTION OF THE DRAWINGS

Examples of the present disclosure will now be described, by way of example only, with reference to the attached Figures.

FIG. 1 is an illustration of the interaction of negatively charged clay particles with polyacrylamide, and electrostatic attraction of the negatively charged clay particles towards positively charged Al(OH)₃ particles.

FIG. 2 is a graph illustrating settling curves for the flocculation of a suspension of 0.5% fine solids in recycled water using different sizes of hybrid particles.

FIG. 3 is a graph illustrating settling curves for the flocculation of a suspension of 5% fine solids in recycled water using different sizes of hybrid particles.

FIG. 4 is a graph illustrating settling curves for the flocculation of a suspension of 10% fine solids in recycled water using different sizes of hybrid particles.

FIG. 5 is a graph illustrating settling curves for the flocculation of a suspension of 20% fine solids in recycled water using different sizes of hybrid particles.

FIG. 6 is a graph illustrating the initial settling rate (m/h) for the flocculation of samples of oil sands mature fine tailings with 5% solids or 10% solids using 500 ppm of different sizes of hybrid particles.

FIG. 7 is a graph illustrating the initial settling rate (m/hr) for the flocculation of samples of oil sands mature fine tailings with 5% solids using different dosages of different sizes of hybrid particles.

FIG. 8 is a graph illustrating the initial settling rate (m/hr) for the flocculation of samples of oil sands mature fine tailings with 10% solids using different dosages of different sizes of hybrid particles.

FIG. 9 is a graph illustrating the yield stress (Pa) for flocs prepared using different sizes of hybrid particles.

FIG. 10 is a flowchart illustrating a method according to the present disclosure.

FIG. 11 is a flowchart illustrating an exemplary method according to the present disclosure.

FIG. 12 is a photograph showing the settling of samples of oil sands mature fine tailings with 30% fine solids in recycled water treated with A4NHP (an exemplary charged particle-polymer hybrid flocculants according to the present disclosure), taken at time 0 and at 24 hours after treatment.

FIG. 13 is a flowchart illustrating an exemplary dual polymer treatment method of the present disclosure.

FIG. 14A is a photograph showing the settling of samples of oil sands mature fine tailings (30% fine solids) in recycled water using SNF3338 as a single polymer flocculant, or SNF3338 in combination with A4NHP, taken 10 minutes after treatment.

FIG. 14B is a photograph showing the settling of samples of oil sands mature fine tailings with 30% fine solids in recycled water using SNF3338 as a single polymer flocculant, or SNF3338 in combination with A4NHP, taken 18 hours after treatment.

FIG. 15 is a graph illustrating the initial settling rate (m/h) for the flocculation of samples of oil sands mature fine tailings with 30% fine solids in recycled water using SNF3338 as a single polymer flocculant, or SNF3338 in combination with A4NHP.

FIG. 16 is a graph illustrating the flocs filtration rate (g/s) for flocculated samples of oil sands mature fine tailings with 30% fine solids in recycled water using SNF3338 as a single polymer flocculant, or SNF3338 in combination with A4NHP.

### DETAILED DESCRIPTION

Generally, the present disclosure provides a combination of flocculants, where the combination comprises (a) an anionic polymer flocculant, and (b) a charged particle-polymer hybrid (CPPH) flocculant that includes charged core particles, each having a polymer polymerized thereon, where the anionic polymer flocculant is to be added before, or at substantially the same time as, the charged particle-polymer hybrid flocculant. In the context of the present disclosure, the expression “a combination of flocculants” is understood to refer to at least two flocculants that are to be used together for flocculating a suspension. For example: the flocculants may be provided separately and added to the suspension separately, for example sequentially or at substantially the same time; or they may be provided together in separate packages, and added to the suspension separately, for example sequentially or at substantially the same time.

Adding the anionic polymer flocculant before, or at substantially the same time as, the charged particle-polymer hybrid flocculant should be understood to mean that the anionic polymer flocculant is added in such a manner that it sufficiently mixes with the suspension to at least form small flocs, before interacting with the charged particle-polymer hybrid flocculant. Preferably, the anionic polymer flocculant is first added to the suspension, homogeneously mixed, and allowed to at least form small flocs, and then the charged particle-polymer hybrid flocculant is added to the suspension. In some examples, the anionic polymer flocculant and the charged particle-polymer hybrid flocculant may be added to the suspension at substantially the same time, but in sufficiently separate locations that the anionic polymer flocculant can mix with the suspension to form small flocs before coming into contact with the charged particle-polymer hybrid flocculant. One specific example of this is the addition of the combination of flocculants to a pipeline that transports a slurry of matured fine tailings. The anionic polymer flocculant may be added upstream of, but at the same time as, the charged particle-polymer hybrid flocculant. In such an example, the anionic polymer flocculant would be added sufficiently upstream of the charged particle-polymer hybrid flocculant to allow the anionic polymer flocculant to at least form small flocs before interacting with the charged particle-polymer hybrid flocculant. In some examples, such as with a suspension of MFT, the term “small flocs” would be understood to refer to flocs that have sizes in the range of microns (for example: from about 25 μm to about 75 μm).

In some embodiments, adding the anionic polymer flocculant before, or at substantially the same time as, the charged particle-polymer hybrid flocculant results in improvement of at least one flocculation parameter in comparison to a combination where the anionic polymer flocculant and the charged particle-polymer hybrid flocculant are mixed and added to the suspension as a mixture.

When solid microscopic substances are dispersed in an aqueous liquid carrier, the substance particles acquire electric charges due to, for example, dissolution of the solid surfaces, ionization of surface groups, adsorption of ions into the liquid carrier from the surface, substitution of ions in a lattice of the particle, or combinations thereof.

The authors of the present disclosure have now observed that there is a surprising connection between the size of the charged core of the CPPH flocculants and the performance in aggregation of solid microscopic substances. Without being bound by theory, the authors of the present disclosure believe that flocculation is enhanced when the charged core is of sufficient size to interact with suspended particles and draw those suspended particles towards the charged core by electrostatic attraction, thereby forming compact floccules. Accordingly, flocculation is believed to be enhanced with CPPH flocculants having larger core sizes than 150 nm.

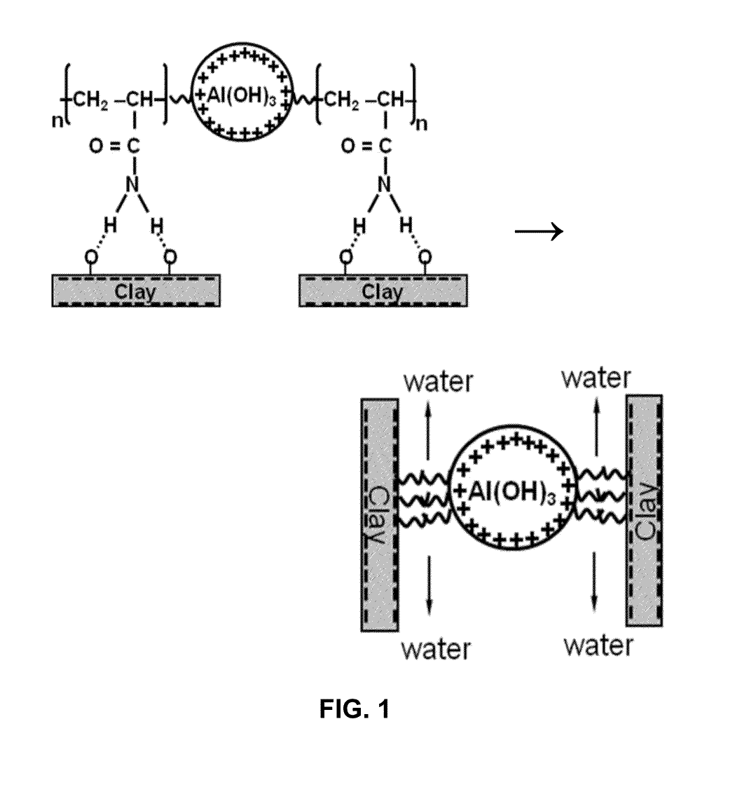

The interaction between CPPH flocculants and microscopic substances is illustrated in FIG. 1, which illustrates a CPPH flocculant that includes a positively charged Al(OH)₃ core and polyacrylamide (PAM) polymerized thereon. FIG. 1 illustrates the interaction of negatively charged clay particles with the PAM, and electrostatic attraction of the negatively charged clay particles towards the positively charged Al(OH)₃ core. The electrostatic attraction associated with the CPPH flocculants is stronger than the attraction of polymers that only use hydrogen bonding to bridge solids together for flocculation.

The authors of the present disclosure have observed that the ability to interact with suspended particles becomes an important factor when the charged core of the CPPH flocculant have an average size between about 150 nm and about 800 nm in diameter. In particular examples, the charged core may have an average size between about 340 nm and about 750 nm. The charged particle-polymer hybrids that have an average core particle size between about 500 nm and about 750 nm are able to induce flocculation of slurries at solids concentrations higher than smaller sized CPPH particles (for example CPPH particles between 50 and 100 nm), as shown in the prior art.

The charged core may include a metal hydroxide. The metal hydroxide may be a transition metal hydroxide. The metal hydroxide may be a multivalent metal hydroxide. In particular examples, the metal hydroxide is Al(OH)₃ or Fe(OH)₃. The charged particle may include a mixture of metal hydroxides.

The size of the charged core may be varied by changing the ratio of reactants used to form the charged core. For example, the charged core may be metal hydroxide core and may be formed by reacting ammonium carbonate with a metal chloride. The ratio between the ammonium carbonate and the metal chloride may be selected in order to control the size of the metal hydroxide core.

Changing the size of the charged core changes the electrostatic forces between the charged cores and the suspended particles that are flocculated. Changing the electrostatic forces affects the flocculant properties. Charged particle polymer hybrids that have different sized charged cores were generated using varying ratios of (NH₄)₂CO₃ to AlCl₃.6H₂O to form differently sized charged Al(OH)₃ core particles. Acrylamide was used as the monomer to form the polymer. Because the polymers were formed under consistent conditions, the resulting polymers have similar average molecular weights of about 4.7*10⁶ Daltons. The different flocculants are summarized in Table 1, below.

TABLE 1

| | | | | Average |
|---|---|---|---|---|
| | | (NH₄)₂CO₃/ | | size of |
| | Charged | AlCl₃ mole | | CPPH (nm) |
| Sample | particle | ratio | Polymer | core |
| a | Al(OH)₃ | 1:1.05 | PAM | 67.2 |
| b | Al(OH)₃ | 1:0.67 | PAM | 100.4 |
| c | Al(OH)₃ | 1:0.50 | PAM | 340.4 |
| d | Al(OH)₃ | 1:0.36 | PAM | 512.2 |
| e | Al(OH)₃ | 1:0.24 | PAM | 716.6 |

Sample “a” corresponds to a charged core particle made following the procedure disclosed by Yang et al. in “A novel flocculant of Al(OH)₃-polyacrylamide ionic hybrid” (Journal of Colloid and Interface Science (2004), 273:2, pp 400-405).

The size distributions of the charged particle polymer hybrids were measured using a Zetasizer Nano Range from Malvern. The system measures size and microrheology using dynamic light scattering (DLS). Dynamic light scattering (DLS), sometimes referred to as Quasi-Elastic Light Scattering (QELS), is a non-invasive, well-established technique for measuring the size and size distribution of molecules and cores typically in the submicron region, and with the latest technology, lower than 1 nm. The size of the charged particle polymer hybrid (CPPH) correlates to the size of the charged particle.

These charged particle polymer hybrids were evaluated for their flocculating ability. Briefly, the CPPHs were tested against different slurries of oil sands MFT tailings from Syncrude (0.5%, 5%, 10% and 20% solids) for their ability to induce flocculation. Settling curves were determined by plotting the mudline position over time. Details of the tests are discussed below. However, a summary of the normalized settling (mudline travel distance at time=t/mudline position at time=0) after 25 minutes is shown in Table 2, below. A value approaching 0% for normalized settling reflects complete flocculation of the solids. A value of 100% for normalized settling reflects no flocculation of the solids.

TABLE 2

| | 0.5% solids, | 5% solids, | | |
|---|---|---|---|---|
| Sample | 30 ppm | 500 ppm | 10%solids, | 20% solids, |
| (size CPPH) | CPPH | CPPH | 800 ppm CPPH | 2000 ppm CPPH |
| a (67 nm) | <10% | 88% | 99% | 88% |
| b (100 nm) | <10% | 99% | 100% | 87% |
| c (340 nm) | <10% | 40% | 100% | 92% |
| d (512 nm) | <10% | 26% | 45% | 74% |
| e (716 nm) | <10% | 32% | 50% | 78% |

The results summarized in Table 2 indicate that charged particle polymer hybrids that have a charged cores with an average size between about 150 nm and about 800 nm have the ability to flocculate slurries of solid particles from oil sands better than CPPHs having an average core size of 100 nm or smaller. In particular, CPPHs that have an average core size of between about 500 nm and about 800 nm have the ability to flocculate some solid particles under conditions where CPPHs with cores of 100 nm and below are not all effective. The authors of the present disclosure attempted to synthesize CPPH's with charged cores having average size above 1 μm but were unsuccessful as the charged cores settled out of solution even with agitation and polymerization with the monomer was not successful.

The polymer polymerized on the charged core particles may be a commercially available flocculating polymer, such as polyacrylamide (PAM). Without being bound by theory, the authors of the present disclosure believe that flocculation is enhanced when (a) the polymer branches extend from the charged particle to which they are attached so as to increase the possibility that the polymer branches will contact and interact with suspended particles, but (b) the polymer branches do not extend so far as to inhibit suspended particles from being drawn towards the charged particle.

The intrinsic viscosity of the CPPH flocculants is affected by the length and shape of the polymer attached to the charged particles. Accordingly, intrinsic viscosity may be considered to be a representative measure of how the polymer branches affect the performance of the CPPH flocculants in aggregating the solid microscopic substances. If the intrinsic viscosity is too low, indicative of short or entangled polymer chains and branches, the effectiveness of the hybrid flocculant in capturing suspended particles is diminished. Conversely, high intrinsic viscosity is understood to indicate high average length for the polymer branches attached to the charged particles, and reduces the electrostatic attraction between captured suspended particles and the charged core particles of the hybrid flocculant, which may result in re-dispersion when over-dosed. In particular examples, the charged particle-polymer hybrid according to the present disclosure may have an intrinsic viscosity between about 210 mL/g and about 1400 mL/g. Preferably, the charged particle-polymer hybrids have an intrinsic viscosity between about 210 mL/g and about 930 mL/g.

Changing the concentration of initiator may change the intrinsic viscosity of the resulting hybrid flocculant. Increasing the concentration of initiator results in a lower intrinsic viscosity for the resulting hybrid flocculants. For example, as shown in Table 3, by doubling the free radical initiator concentration used in the synthesis of aluminum-hydroxide-PAM hybrid flocculants, the intrinsic viscosity is reduced by about 40%.

TABLE 3

| | | | | |
|---|---|---|---|---|
| Initiator concentration | 0.0667 | 0.0667 | 0.0667 | 0.133 |
| (wt. initiator/wt. monomer) | | | | |
| Intrinsic Viscosity (mL/g) | 1120 | 1146 | 1230 | 766 |

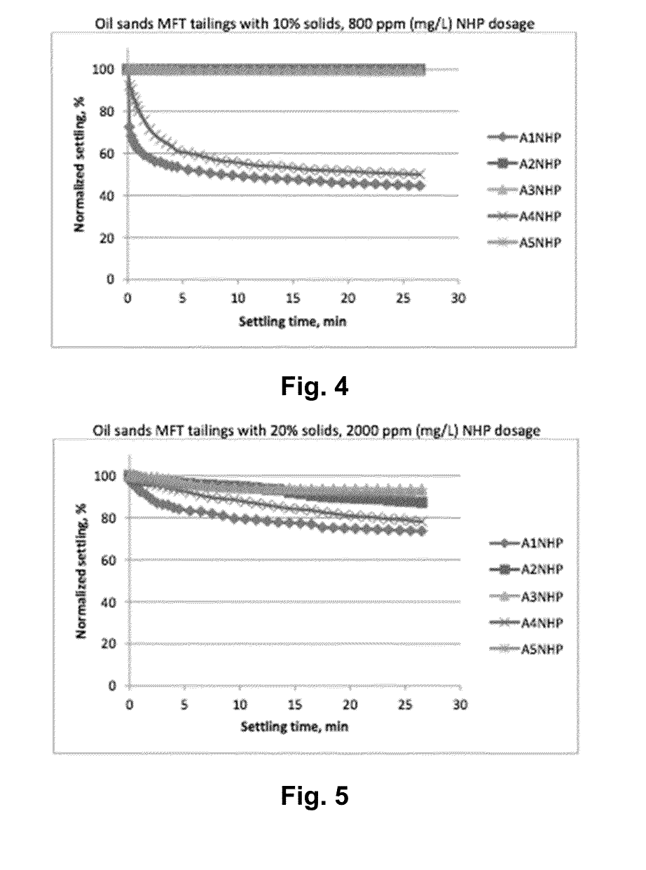

The CPPH flocculant according to the present disclosure may be used to help aggregate microscopic substances that are suspended in a liquid carrier, for example, in the treatment of oil sands tailings. It may be preferable to use particular examples of the CPPH flocculant according to the present disclosure in the treatment of oil sands tailings, such as MFT or FFT. As discussed above, oil sands tailings predominantly have clay particles with diameters smaller than 10 microns (10,000 nm), and may have particles with sizes from about 50 to about 500 nm. Such particles are preferably flocculated using CPPH flocculants between about 340 nm and about 750 nm. As discussed above, oil sands tailings may have up to about 35 wt. % solids. As shown in FIGS. 4 and 5, at higher solids contents, such as greater than 10% solids, it may be preferable to use CPPH flocculants between about 500 nm and about 750 nm.

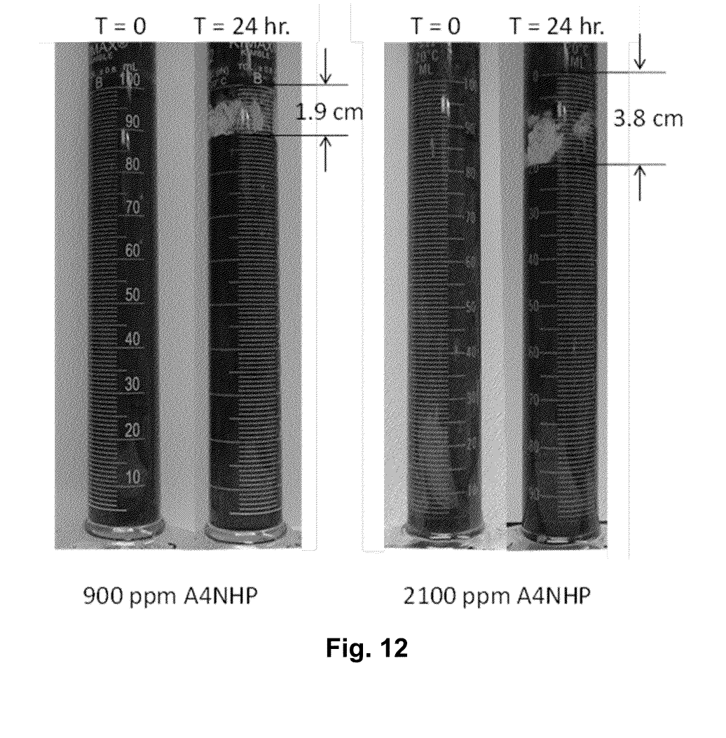

The CPPH flocculant according to the present disclosure may also be used on its own to treat MFT with very high solids content (30% solids); although the settling rate is very low as illustrated in FIG. 12. The settling rate of the MFT treated with 900 ppm of A4NHP is 1.9 cm/24 hours (<0.01 m/hr). The settling rate of the MFT treated with 2100 ppm of A4NHP is 3.8 cm/24 hours (<0.02 m/hr).

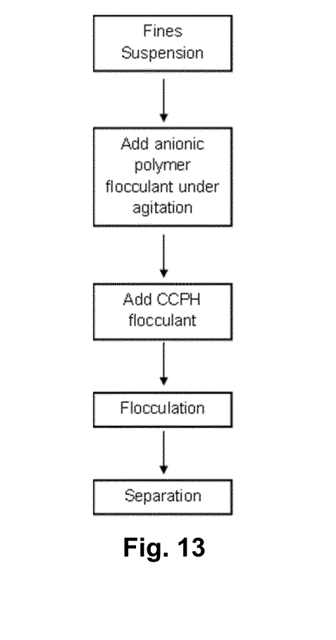

The CPPH flocculant according to the present disclosure may be used as part of a combination polymer system in the treatment of oil sands tailings, where the CPPH flocculants are used in combination with an anionic polymer flocculant. The present disclosure provides a method of polymer flocculation whereby an anionic polymer flocculant may be added first to a fines suspension under agitation, followed by the CPPH flocculant, as shown in FIG. 13. Combination flocculants according to the present disclosure may be used for flocculation of MFT at high solids content (≧20% solids), and may allow the total flocculant dosage to be reduced compared to use of a single polymer. The ratio of anionic polymer to CPPH flocculant may be from about 1:1 to about 1:5, and preferably from about 1:1 to 1:2.

Suitable anionic polymer flocculants that may be combined with a CPPH flocculant according to the present disclosure include: PAM-based polymer flocculants. Preferred PAM-based polymer flocculants have a high molecular weight (>1×10⁶ Daltons). The anionic polymer flocculants may be branched or linear, with branched polymers being preferred. The most preferred anionic polymer is the anionic, branched PAM-based SNF3338.

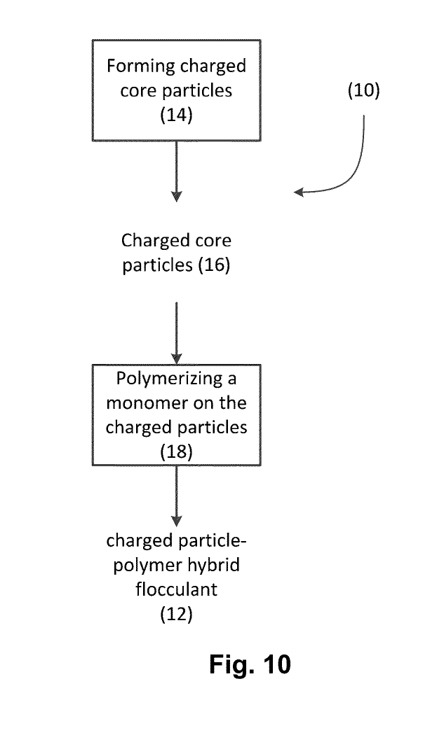

The present disclosure also provides a method (10) of forming a charged particle-polymer hybrid flocculant (12) that includes charged particles having an average core size between about 150 nm and about 800 nm and each having a polymer polymerized thereon. The method is illustrated in FIG. 10. The method (10) includes: forming (14) charged core particles (16) having an average size between about 150 nm and about 800 nm; and polymerizing a monomer on the charged particles (18) to form the polymer. The charged core particles may have an average size between about 340 nm and about 750 nm.

The charged particle may include a metal hydroxide. The metal hydroxide may be a transition metal hydroxide. The metal hydroxide may be a multivalent metal hydroxide. In particular examples, the metal hydroxide is Al(OH)₃ or Fe(OH)₃. The charged particle may include a mixture of metal hydroxides.

The method may include selecting an amount of polymerizing initiator to control the intrinsic viscosity of the charged particle-polymer hybrid flocculant. The amount of polymerizing initiator may be selected to result in the intrinsic viscosity being between about 210 mL/g and about 1400 mL/g. The wt/wt ratio of the initiator to the monomer may be between 0.667 and 0.133. The polymer may be a polyacrylamide polymer.

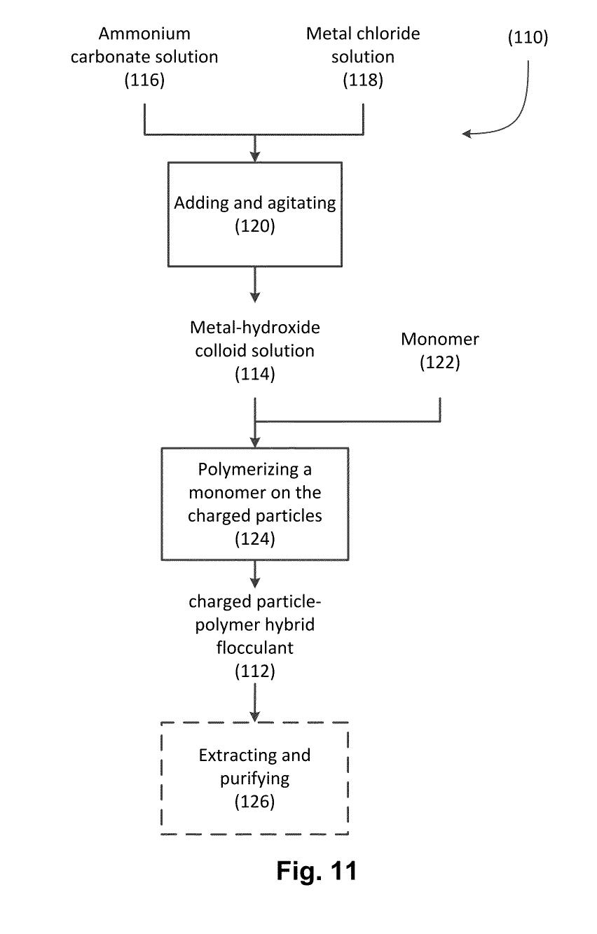

In one exemplary method (110), illustrated in FIG. 11, the charged core particle includes a metal hydroxide and the charged particle polymer hybrid (112) is formed by: preparing a metal-hydroxide colloidal solution (114) by a slow and drop-wise addition of an ammonium carbonate solution (116) into a metal chloride solution (118) under agitation at room temperature (120); dissolving a monomer (122), such as acrylamide, in the metal-hydroxide colloidal solution; and polymerizing (124) the monomer by the addition of an initiator, such as a free radical initiator, or a light source. Nitrogen gas may be introduced to the reaction vessel prior to addition of the initiator. The reaction vessel may be sealed and polymerization may proceed at an elevated temperature, such as 40° C. The polymerized charged particle-polymer hybrid may be extracted and purified (126) by adding the reaction solution to deionized water, thereby precipitating at least a portion of the impurities, and extracting purified charged particle-polymer hybrid with an acetone solution.

### Examples

The following examples serve merely to further illustrate embodiments of the present invention, without limiting the scope thereof, which is defined only by the claims appended hereto.

### Synthesis of a Charged Particle Polymer Hybrids of Varying Average Size

A metal-hydroxide colloidal solution was prepared comprising sub-micron core particles of metal-hydroxide. Al(OH)₃ colloid solutions are controlled by the mole ratio of reagents (NH₄)₂CO₃ to AlCl₃.6H₂O. The smaller of the mole ratio, the larger the core.

The Al(OH)₃ colloid solutions were prepared by dissolving a weighted amount of (NH₄)₂CO₃ and AlCl₃.6H₂O in separate volumes of deionized (DI) water. The (NH₄)₂CO₃ solution was slowly added drop-wise into the AlCl₃.6H₂O solution in a beaker under strong agitation (approx. 1,500 rpm) at room temperature. Agitation increases the uniformity of the metal-hydroxide colloidal particulate size. The reagents reacted according to the following reaction:

2AlCl₃+3(NH₄)₂CO₃+3H₂O→2Al(OH)₃+6(NH₄)Cl+3CO₂

Charged core particle solutions were made at varying mole ratios of (NH₄)₂CO₃/AlCl₃. Acrylamide monomer was dissolved in the metal-hydroxide colloidal solutions and polymerized by the addition of (NH₄)₂S₂O₈—NaHSO₃ as an initiator. Sufficient amounts of 0.075 wt % NaHSO₃ and 0.15 wt % (NH₄)₂S₂O₈ were added to 30 ml of metal-hydroxide colloidal solution containing 4.5 g acrylamide in a 2000 ml flask to result in polymers having molecular weights of about 4.7*10⁶ Daltons. Nitrogen gas was introduced to the flask for 30 minutes before addition of the initiator. After addition of the initiator, the flask was sealed and polymerization was allowed to proceed for 8 h at 40° C. This resulted in charged particle polymer hybrids of varying sizes, see Table 4.

TABLE 4

| | | | Mole ratio |
|---|---|---|---|
| | Charged | Average Size of | (NH₄)₂CO₃/ |
| Sample | particle | CPPH (nm) | AlCl₃ |
| a | Al(OH)₃ | 67.2 | 1:1.05 |
| b | Al(OH)₃ | 100.4 | 1:0.76 |
| c | Al(OH)₃ | 340.4 | 1:0.50 |
| d | Al(OH)₃ | 512.2 | 1:0.36 |
| e | Al(OH)₃ | 716.6 | 1:0.24 |

The resulting charged particle polymer hybrids were extracted and purified by adding the reaction solutions to deionised water, precipitating impurities, and extracting pure charged particle polymer hybrid with an acetone solution. This procedure may be repeated two or more times. The extracted material was dried at 50° C. in a vacuum oven.

The size distribution of the charged particles was measured using a Zetasizer Nano Range from Malvern. The system measures size and microrheology using dynamic light scattering (DLS). Dynamic light scattering (DLS), sometimes referred to as Quasi-Elastic Light Scattering (QELS), is a non-invasive, well-established technique for measuring the size and size distribution of molecules and particles typically in the submicron region, and with the latest technology measuring at lengths less than 1 nm.

Intrinsic viscosity measurements were conducted with an Ubbelohde viscometer at 30° C.

### Preparation of Test Suspensions

The suspensions used for testing the charged particle polymer hybrids were prepared by mixing mature fine tailings slurry (37% wt. solids) from Syncrude with recycled water from Syncrude at specific solids concentrations (05.%, 5%, 10% or 20% solid concentration). Solutions of the CPPH particles were prepared at 4 mg/mL.

### Flocculation Testing

The fine solid suspension, CPPH solution, and sufficient recycled water were mixed to result in 50 mL of a testing solution. The 0.5% solids solution was tested with 30 ppm CPPH particles; the 5% solids solution was tested with 500 ppm CPPH particles; the 10% solids solution was tested with 800 ppm CPPH particles; and the 20% solids solution was tested with 2000 ppm CPPH particles.

Settling tests were conducted using a digital camera to take pictures of the testing solution in a 50 mL graduated cylinder.

The settling curves were determined by measuring the midline travel distance at various times. The settling curves are based on the normalized settling (%) vs. settling time (min), where normalized settling (%)=mudline travel distance at time=t/mudline position at time=0.

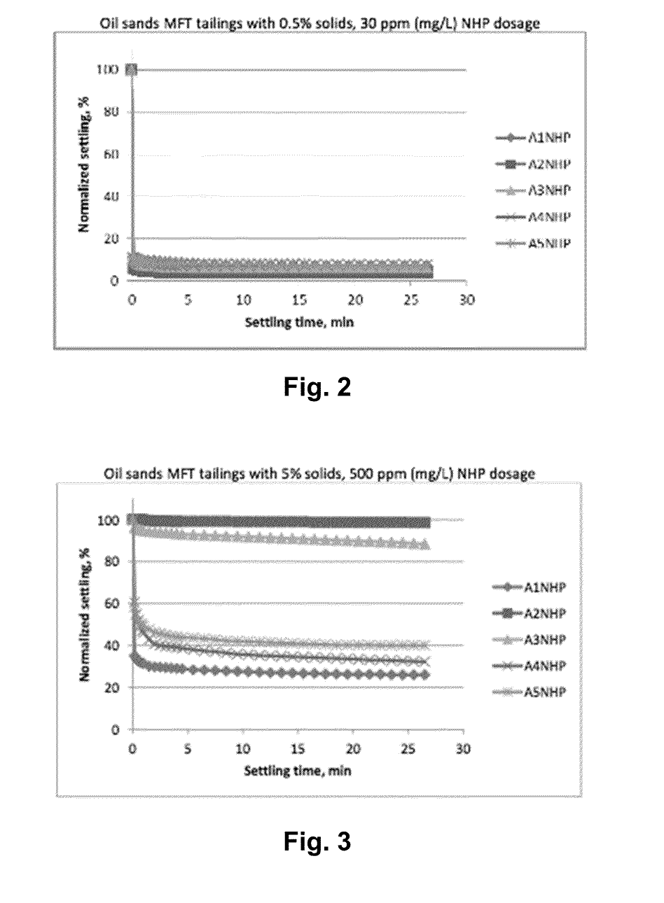

The results for the flocculation of the 0.5% solids are shown in the graph in FIG. 2. The results for the flocculation of the 5% solids are shown in the graph in FIG. 3. The results for the flocculation of the 10% solids are shown in the graph in FIG. 4. The results for the flocculation of the 20% solids are shown in the graph in FIG. 5.

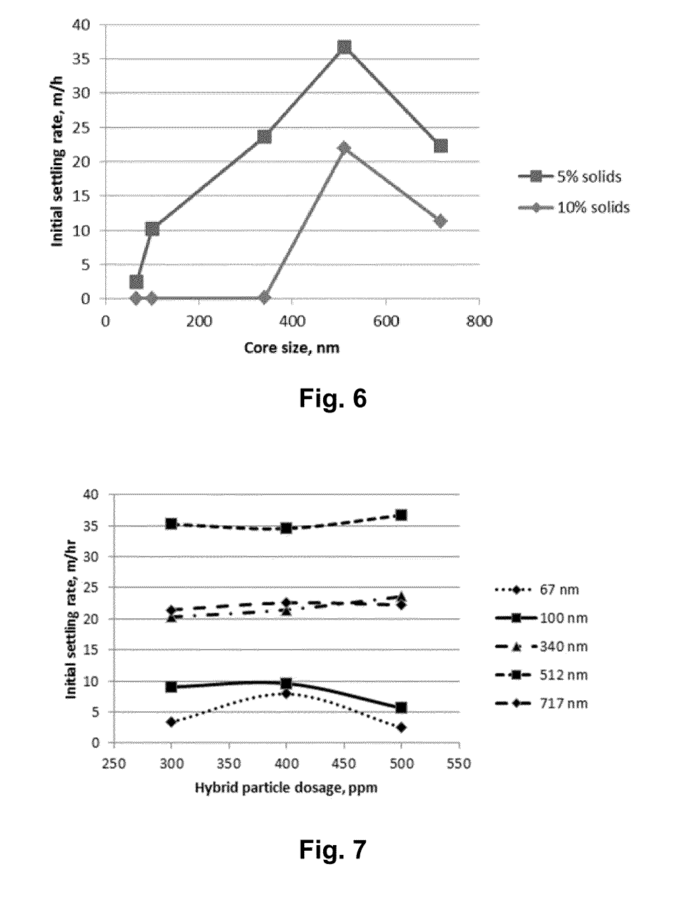

The initial settling rates for the data used in FIGS. 3 and 4 are illustrated in FIG. 6. Initial settling rates reflect the initial slope of the non-normalized settling data. The expression “core size” refers to the size of the charged particle polymer hybrid.

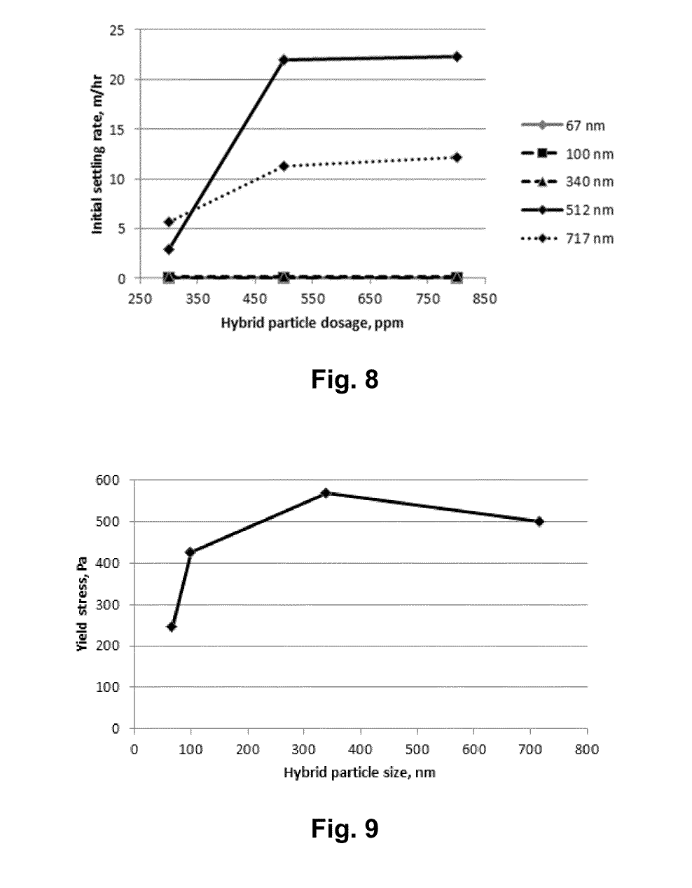

As noted above, the authors of the present disclosure believe that, at least for some concentrations of oil sands mature fine tailings, the flocculating efficacy is more a function of the size of the flocculant particles for a given percent solids, and less a function of the concentration (ppm) of flocculant particles used. This is illustrated in FIGS. 7 and 8.

FIG. 7 shows the initial settling rates of oil sands mature fine tailings with 5% solids, at concentrations ranging from 300 ppm to 500 ppm of variously sized flocculant particles. The initial settling rate is not significantly affected by the concentration (ppm) of particles used, but does vary between differently sized particles.

FIG. 8 shows the shows the initial settling rates of oil sands mature fine tailings with 10% solids, at concentrations ranging from 300 ppm to 800 ppm of variously sized flocculant particles. Once a threshold concentration has been reached (about 500 ppm), the initial settling rate is not significantly affected by the concentration (ppm) of the 512 nm or 717 nm particles being used, but does vary between differently sized particles.

In FIGS. 2-5:
i. A1NHP=Sample d (512 nm particle size)
ii. A2NHP=Sample b (100 nm particle size)
iii. A3NHP=Sample a (67 nm particle size)
iv. A4NHP=Sample e (716 nm particle size)
v. A5NHP=Sample c (340 nm particle size)

### Yield Stress Testing

The results for the yield stress testing are shown in FIG. 9. To obtain the data, 1000 ml samples of 37% wt. solids mature fine tailing were mixed with variously sized flocculants. The mixtures were allowed to settle for 24 hrs. A Brookfield R/S Rheometer, with a V20×20 vane probe, was used to obtain the yield stress. The vane was slowly inserted into a formed flocculated sediment so that the vane could be located in the middle of the sediment. The position was then kept for all other measurements to ensure that all the measurements were made at the same depth of sediment. The yield stress was obtained from the recorded data and the curve automatically plotted by the software. All the measurements were done at room temperature.

CPPH particles according to the present disclosure having particle sizes of 340 nm and 716 nm provided flocs with yield stresses above 500 Pa, while CPPH particles having sizes of 67 nm and 100 nm provided flocs with yield stresses below 450 Pa.

### Combination Flocculants

Preparation of Test Suspensions

The suspensions used for testing the charged particle polymer hybrids and anionic polymer flocculants, alone or in combination, were prepared by mixing mature fine tailings slurry (38.4% wt. solids) with recycled water at 30% solids concentrations. Solutions of the CPPH flocculant (A4NHP) and SNF3338 were prepared in 0.4% solution using process water.

Flocculation Testing

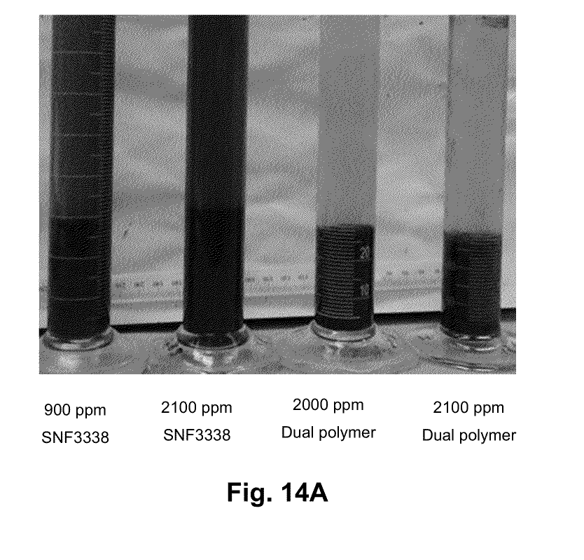

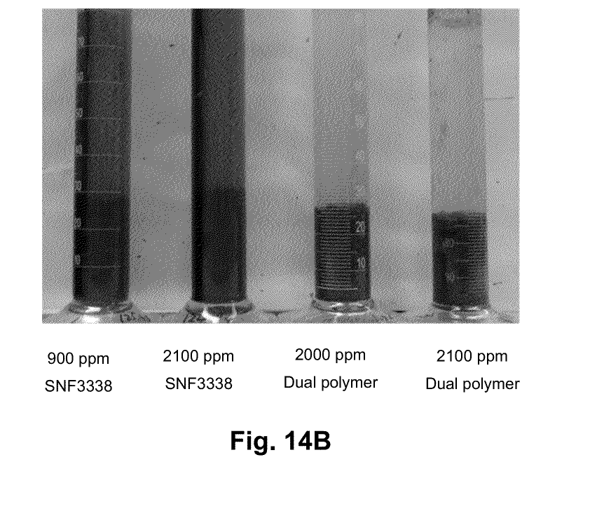

For single polymer experiments, A4NHP or SNF3338 flocculant was added to the fine solid suspensions at 900 ppm or 2100 ppm, under agitation. For graduated cylinder experiments, agitation was performed by inverting the cylinder 20 times; for all other experiments, agitation was done using an impeller at 600 rpm. For dual polymer experiments, the A4NHP flocculant was then added at 1100 ppm or 1200 ppm (where SNF3338 concentration is 900 ppm), for total flocculant concentrations of 2000 ppm or 2100 ppm respectively. Settling tests were conducted using a digital camera to take pictures of the testing solution in a graduated cylinder. Settling was determined by measuring the interface distance from the bottom at various times. Initial settling rates reflect the initial slope of the non-normalized settling data. FIG. 12 shows the settling of 30% solids MFT after treatment with 900 or 2100 ppm A4NHP. After 24 hours, settling rates were <0.01 m/hr and <0.02 m/hr, respectively. FIG. 14 shows the settling of 30% solids MFT after 10 minutes (FIG. 14A) and 18 hours (FIG. 14B) for single SNF3338 treatment and dual polymer treatments. FIG. 14 shows the initial settling rates for the same. The results indicated that the dual polymer system strongly increases flocculation ability and settling rate of MFT compared to either single polymer treatment. The total dosage of 2000 or 2100 ppm is much lower than the dose of SNF3338 alone to flocculate MFT.

The solid content of the flocculated test samples were determined after 18 hours. The results in Table 5, below, indicate that the dual polymer system results in more consolidated sediments than single polymer.

TABLE 5

| | | | 900 ppm | 900 ppm |
|---|---|---|---|---|
| | | | SNF3338 + | SNF3338 + |
| | 900 ppm | 2100 ppm | 1100 ppm | 1200 ppm |
| | SNF3338 | SNF3338 | A4NHP | A4NHP |
| Volume (mL) | 29 | 33 | 28 | 28 |
| Solid Content (%) | 35-40 | 35-40 | >40 | >40 |

Yield stress was measured using the method described above and the results are shown in Table 6, below. The results demonstrate that the dual polymer system results in greater yield stress, and therefore enhanced shear strength. In contrast, the higher dosage of SNF3338 alone (2100 ppm) resulted in re-dispersing the MFT sample, thereby leading to a much reduced yield stress (i.e. much less than 406 Pa).

TABLE 6

| | | | 900 ppm | 900 ppm |
|---|---|---|---|---|
| | | | SNF3338 + | SNF3338 + |
| | 900 ppm | 2100 ppm | 1100 ppm | 1200 ppm |
| | SNF3338 | SNF3338 | A4NHP | A4NHP |
| Yield Stress (Pa) | 406 | — | 581 | 743 |

Flow Index was calculated as the slop of the flow curve used to determine the Liquid Limit of the sediment following ASTM standard method D4318. The flow index indicates the rate of loss in shearing strength of the sediment upon increase in water content. The results of flow index measurements are shown in Table 7, below. Dual polymer treated sediments exhibit lower Flow Index, indicating slower loss of shear strength upon the increase in water content, and higher shear strength once the sediment is dried approaching its Plastic Limit.

TABLE 7

| | | | 900 ppm | 900 ppm |
|---|---|---|---|---|
| | | | SNF3338 + | SNF3338 + |
| | 900 ppm | 2100 ppm | 1100 ppm | 1200 ppm |
| | SNF3338 | SNF3338 | A4NHP | A4NHP |
| Flow Index | 10.5 | — | 7.9 | 6.4 |

Flocs Filtration Rate

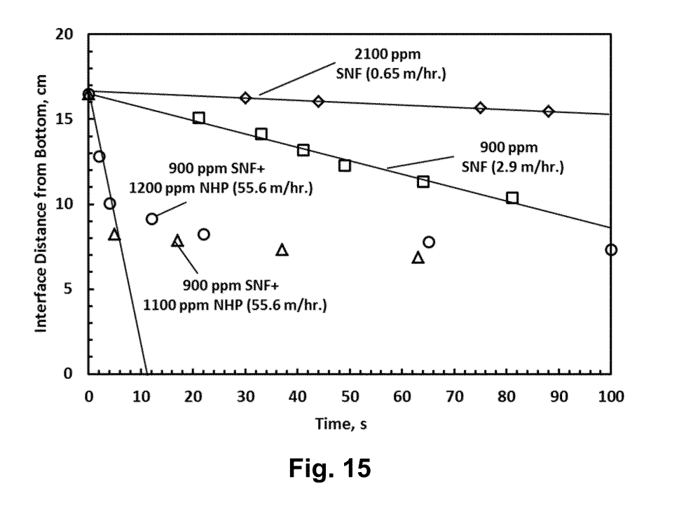

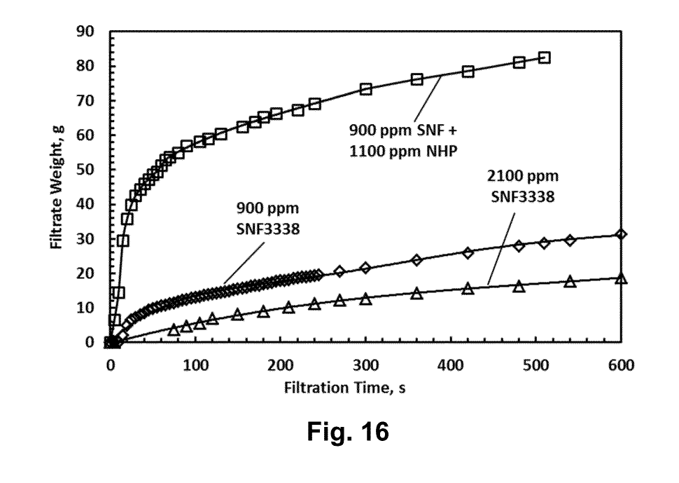

The flocs filtration rate of 10% solids slurry was determined using pressure filtration with a filter press at 30 psi. The results shown in FIG. 15 demonstrate that the dual polymer treatment greatly increases the filtration rate of the flocculated solids.

Alternative Anionic Polymers

Tests were also done combining A4NHP with MagnaFloc1011 and BASF ETD 9010 using MFT samples at 30% solids content. Both dual polymer systems increased yield stress and resulted in more consolidated sediments, although the effect was not as strong as with SNF3338 at equivalent doses.

Comparison with Cationic and Non-Ionic Polymer Flocculants

No improvement in flocculation was identified when using cationic polymer flocculants. Additionally, in comparison to anionic polymer flocculants, the flocculation when using non-ionic polymer flocculants required higher dosages to achieve a comparable flocculating effect.

The authors of the present disclosure compared the following three commercial polymers, obtained from Jucheng Fine Chemicals Co., Ltd, China: GA6517 (anionic PAM, medium high MW); C6260 (cationic PAM, medium high MW); and N682 (non-ionic PAM, medium MW). The polymers were separately added to a suspension of 5% wt MFT and observed after 3 minutes of flocculation.

Adding 12 ppm of GA6517 polymer followed by 8 ppm of A4NHP resulted in good flocculation after 3 minutes. Adding 28 ppm of C6260 followed by 8 ppm of A4NHP showed no flocculation. Adding 28 ppm of N682 followed by 8 ppm of A4NHP resulted in good flocculation after 3 minutes.

Adding 8 ppm of GA6517, C6260, or N682 to the suspension as the only flocculant showed no appreciable flocculation.

Comparison of how Flocculants are Mixed

No improvement in flocculation was identified when A4NHP was added to a suspension of MFT first, followed by addition of SNF3338. Additionally, no improvement in flocculation was identified when A4NHP and SNF3338 were pre-mixed and then added to a suspension of MFT.

In the preceding description, for purposes of explanation, numerous details are set forth in order to provide a thorough understanding of the examples. However, it will be apparent to one skilled in the art that these specific details are not required.

The above-described examples are intended to be exemplary only. Alterations, modifications and variations may be effected to the particular examples by those of skill in the art without departing from the scope, which is defined solely by the claims appended hereto.

What is claimed is:

1. A combination of flocculants for flocculating fines solids in a suspension thereof, the combination comprising:
(a) an anionic polymer flocculant, and
(b) a charged particle-polymer hybrid flocculant comprising charged core particles having an average size between about 150 nm and about 800 nm and each having a polymer polymerized thereon;
wherein the anionic polymer flocculant is to be added before, or at substantially the same time as, the charged particle-polymer hybrid flocculant.

2. The combination of flocculants according to claim 1, wherein the charged core particles have an average size between about 340 nm and about 750 nm.

3. The combination of flocculants according to claim 2, wherein the charged core particles have an average size between about 500 nm and about 750 nm.

4. The combination of flocculants according to claim 1, wherein the charged particle-polymer hybrid flocculant has an intrinsic viscosity between about 210 mL/g and about 1400 mL/g.

5. The combination of flocculants according to claim 1, wherein the charged core particle comprises a metal hydroxide.

6. The combination of flocculants according to claim 5, wherein the metal hydroxide is a transition metal hydroxide.

7. The combination of flocculants according to claim 5, wherein the metal hydroxide is a multivalent metal hydroxide.

8. The combination of flocculants according to claim 5, wherein the metal hydroxide is Al(OH)₃ or Fe(OH)₃.

9. The combination of flocculants according to claim 1, wherein the polymer polymerized on the charged core particles is a polyacrylamide.

10. The combination of flocculants according to claim 1, wherein the anionic polymer flocculant is an anionic polyacrylamide polymer.

11. The combination of flocculants according to claim 10, wherein the anionic polyacrylamide polymer has a molecular weight of at least 1×10⁶ Daltons.

12. The combination of flocculants according to claim 10, wherein the anionic polyacrylamide polymer is branched.

13. The combination of flocculants according to claim 10, wherein the anionic polyacrylamide polymer is SNF 3338.

14. The combination of flocculants according to claim 1, wherein:
the anionic polymer flocculant is SNF 3338, and
the charged particle-polymer hybrid flocculant comprises Al(OH)₃ charged core particles having an average size of about 716 nm, with the Al(OH)₃ charge core particles having an polyacrylamide polymerized thereon where the average molecular weight of the polyacrylamide is about 4.7*10⁶ Daltons.

15. The combination of flocculants according to claim 1, wherein the anionic polymer flocculant and the charged particle polymer hybrid are used in a ratio of about 1:1 to 1:5.

16. The combination of flocculants according to claim 1, wherein the anionic polymer flocculant and the charged particle polymer hybrid are used in a ratio of about 1:1 to 1:2.

17. The combination of flocculants according to claim 1, wherein the anionic polymer flocculant and the charged particle-polymer hybrid flocculant are separate, and are for adding separately to the suspension of fines solids.

18. The combination of flocculants according to claim 17, wherein the anionic polymer flocculant is for adding to the suspension of fines solids before the charged particle-polymer hybrid flocculant.
